(19) United States
(12) Patent Application Publication
(10) Pub. No.: US 2010/0229022 A1
(43) Pub. Date: Sep. 9, 2010

(54) COMMON TROUBLESHOOTING FRAMEWORK

(75) Inventors: Gaurav S. Anand, Seattle, WA (US); Aaron Spinks, Kirkland, WA (US); Kai Chen, Sammamish, WA (US); Matthew M. Kerner, Seattle, WA (US); Jwalin Buch, Kirkland, WA (US); Donovan P. Regan, Seattle, WA (US); Rajeev Dutt, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/396,889

(22) Filed: Mar. 3, 2009

(51) Int. Cl. G06F 11/07; G06F 3/048

(52) U.S. Cl. 714/2; 715/708; 714/E11.025; 714/E11.024; 714/E11.023

(57) ABSTRACT

Techniques for improving a troubleshooting experience by providing a common troubleshooting framework. Such a framework may enable use of common elements between troubleshooters and lead to similarities between troubleshooting packages, which may improve the user experience. Further, a framework may reduce the amount of knowledge and time necessary to create troubleshooting packages, and thus encourage increased development of these troubleshooting packages. In some implementations of the framework, a troubleshooting package may be implemented in a declarative manner that outlines/describes the problems it solves and the potential solutions to those problems. The declarative troubleshooting packages may then be provided to the troubleshooting framework and may provide direction to the framework, in that the framework may execute functions as directed by the troubleshooter.

### BACKGROUND

Some users of computing devices, such as users of personal computers, are not technically savvy enough to diagnose or solve problems that they experience when using those computing devices. These problems may be related to hardware, software, or both. If such a user has a problem, that user typically must ask a friend or family member to help the user diagnose and resolve the problem, or must take the device to a service center and pay for service. This is inconvenient for the user.

To provide assistance to such unsavvy users, some hardware and/or software vendors have developed and distributed troubleshooters that seek to automatically diagnose and cure these problems, or that direct the user through a series of steps to diagnose and cure the problem. These troubleshooters are related to diagnosing and curing common problems associated with the functionality that vendor distributes. For example, a vendor of word processing software may distribute a troubleshooter for spell check functionality of the software, and a vendor of an audio output card for a personal computer may distribute a troubleshooter for problems that may occur with the card (e.g., no sound is being produced).

These troubleshooters are developed independently of each other by each of the vendors that create and distribute them. Each troubleshooter may have its own way of diagnosing and curing problems. Accordingly, each of these troubleshooters may have a unique interface and unique method for diagnosing and curing these problems.

### SUMMARY

Conventional troubleshooting tools are developed independently of one another, and thus have differences in how they operate and in how they interact with a user. Applicants have appreciated that these tools are typically used by users that are not technically savvy, and have further appreciated that these differences may frustrate these users and prevent the users from making full use of these tools. Further, Applicants have appreciated that because each of these tools must be developed in total, there is a significant amount of knowledge and time required to develop troubleshooters.

Described herein are various principles for improving a troubleshooting experience by providing a common troubleshooting framework. This framework may be implemented as part of a computer operating system (OS). Such a framework may lead to similarities between troubleshooting tools, which may improve the user experience. Further, a framework may reduce the amount of knowledge and time necessary to create troubleshooting tools, and thus encourage increased development of these troubleshooting tools.

In some implementations of the framework, a troubleshooting tool may be implemented as a troubleshooting package that directs operation of the common troubleshooting framework. The troubleshooting package may, in some such implementations, be implemented in a declarative manner that outlines the problems it solves and the potential solutions to those problems. The declarative troubleshooting package may then be hooked into the framework and provide direction to the framework, such that the framework may execute functions as directed by the troubleshooting package. In some implementations, the framework may have a single user interface for use by the troubleshooting packages that may be populated with information from the declarative troubleshooting package, such that users may have a unified interface with which they can become accustomed and feel more comfortable.

In one embodiment, there is provided a method of operating a computing device, on which is implemented a troubleshooting framework, to troubleshoot a problem being experienced by the computing device. The method comprises identifying a troubleshooting package to be executed, where the troubleshooting package comprises a problem statement relating to the problem and an identification of one or more causes of the problem. The method further comprises controlling a troubleshooting framework based on contents of the troubleshooting package, where the troubleshooting framework renders a user interface populated according to the contents of the troubleshooting package.

In another embodiment, there is provided at least one computer-readable storage medium encoded with computer-executable instructions that, when executed by a computer, cause the computer to carry out a method of operating a computing device, on which is implemented a troubleshooting framework, to troubleshoot a problem being experienced by the computing device. The method comprises presenting to a user a listing of at least one potential troubleshooting package useful in troubleshooting the problem, where each troubleshooting package comprises a problem statement relating to the problem, an identification of one or more root causes of the problem, and at least one set of computer-executable instructions that performs one of diagnosing, resolving, or verifying solution of a cause of the one or more root causes of the problem. The method further comprises controlling a troubleshooting framework based on contents of a selected troubleshooting package. The troubleshooting framework renders a user interface populated according to the contents of the selected troubleshooting package. The method further comprises, upon completion of processing associated with the selected troubleshooting package, reporting to a repository of troubleshooting information whether the troubleshooting package was successful in solving the problem.

In a further embodiment, there is provided an apparatus, on which is implemented a troubleshooting framework, to troubleshoot a problem being experienced by a user of the computing device. The apparatus comprises at least one processor adapted to perform a troubleshooting process for the troubleshooting framework by reviewing contents of a troubleshooting package, where the troubleshooting package comprises a description of at least one task to be carried out as part of the troubleshooting process. The at least one processor is further adapted to interpret the contents to identify at least one function to be performed to carry out the at least one task, and perform the at least one function.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B are block diagrams of one type of computing device in which some implementations of the techniques described herein may act;

FIG. 2 is a block diagram of an exemplary implementation of a troubleshooting framework in accordance with some of the principles described herein;

FIG. 3 is a flowchart of an exemplary process for troubleshooting a problem experienced by a user that may be implemented in some embodiments of a troubleshooting framework;

FIGS. 4A to 4E are screenshots of an exemplary user interface of a troubleshooting framework that may be used for executing a first illustrative troubleshooting package;

FIGS. 5A to 5C are screenshots of an exemplary user interface of a troubleshooting framework that may be used for executing a second illustrative troubleshooting package;

FIG. 6 is a screenshot of one exemplary report that may be produced by a troubleshooting framework for display to a user regarding results of execution of an illustrative troubleshooting package;

FIG. 7 is a block diagram of an exemplary troubleshooting package that may be used by some embodiments of a troubleshooting framework;

FIGS. 8A and 8B show one illustrative example of a troubleshooting manifest that may be included in a troubleshooting package;

FIG. 9 is a flowchart of an exemplary process that may be followed by a troubleshooting framework when executing a troubleshooting package; and

FIG. 10 is a block diagram of an exemplary computing device in which some implementations of the principles described herein may act.

### DETAILED DESCRIPTION

Applicants have recognized and appreciated that development of troubleshooting tools is a difficult process that has a high knowledge bar. To develop troubleshooting tools, a developer needs information not only on the problems that are to be detected and resolved, including their potential causes and solutions, but also the knowledge on how to develop and distribute tools for use by users. For example, a developer of a troubleshooting tool needs to have knowledge on how to construct user interfaces to permit users to make use of the troubleshooting tools. Accordingly, some potential developers of troubleshooting tools may be deterred from such development if they do not meet the high knowledge bar for development.

Applicants have further recognized and appreciated that when troubleshooting tools are developed, these troubleshooting tools are, generally, in some way unique or different from other troubleshooting tools, as they are individually developed. There may be very little, or no, similarity between the techniques employed by these tools, or the interfaces by which they interact with a user. Applicants have also appreciated that these tools are often used by users who are not technically savvy, and that these users may be deterred from using these tools by a lack of familiarity with them.

In view of the foregoing, described herein are various principles for improving a troubleshooting experience through the use of a common troubleshooting framework. In some implementations, a troubleshooting framework may provide common components of troubleshooting tools, such as user interfaces, for use by troubleshooting tools, such that developers are not required to individually develop these common components. These common components may then be combined with one or more troubleshooting packages implemented in a declarative manner that outline the problems they solve and the potential solutions to those problems. “Declarative” troubleshooting packages are those that provide direction in the form of a description of what task is to be accomplished, as opposed to how the task is to be accomplished. The declarative troubleshooting packages may be hooked into the troubleshooting framework and provide direction to the framework, in that the framework may execute functions according to tasks defined by the declarative troubleshooting package. These functions may be provided by the troubleshooting framework—such as where the troubleshooting framework selects and executes functions based on the tasks described by the package and/or by the declarative troubleshooting package in the form of resources distributed with the declarative troubleshooting package—such as where the package includes scripts or other instructions that are provided to the framework for execution. Accordingly, in one exemplary implementation, a troubleshooting tool may be created through provision of a troubleshooting package, that describes the tasks and flow of a troubleshooting process for diagnosing and solving a particular problem, to a troubleshooting framework, that reviews the description in the troubleshooting package and executes functions to carry out the troubleshooting process based on the description.

In this way, the bar for development of troubleshooting tools may be lowered and development of troubleshooting tools may be increased. Further, through the provision of common components to the troubleshooting tools, these troubleshooting tools may take on similar characteristics, such as similar interfaces and techniques, and may become easier for users to use and become familiar with.

The techniques described herein for troubleshooting problems may be used with any suitable component of a computing device that may experience errors. Components that may experience problems include software components, such as system software (e.g., an operating system) of a computing device or application software installed/executing on a computing device, and hardware components, including any of the hardware/circuitry of a computing device as well as any peripheral devices connected to a computing device.

Accordingly, it should be appreciated that troubleshooting techniques implemented in accordance with the principles described herein may operate on any suitable computing system, comprising any type or types of components, including any suitable hardware and/or software components, to troubleshoot problems being experienced by any one or more components of a computing device. Embodiments of the invention are not limited to being implemented on or with any particular type of computing device or any particular components of a computing device.

Further, techniques described herein may be useful for troubleshooting any type of problem in any environment or scenario, apart from problems with components of a computing device. These problems may be in computing environments apart from individual computing devices, such as troubleshooting problems with computing networks such as enterprise networks. In other cases, these problems may not be related to computing environments and may be used in any other suitable environment to troubleshoot problems in those areas, such as in troubleshooting process problems with enterprise workflows outside of a computing device or in troubleshooting problems with cars or other automobiles.

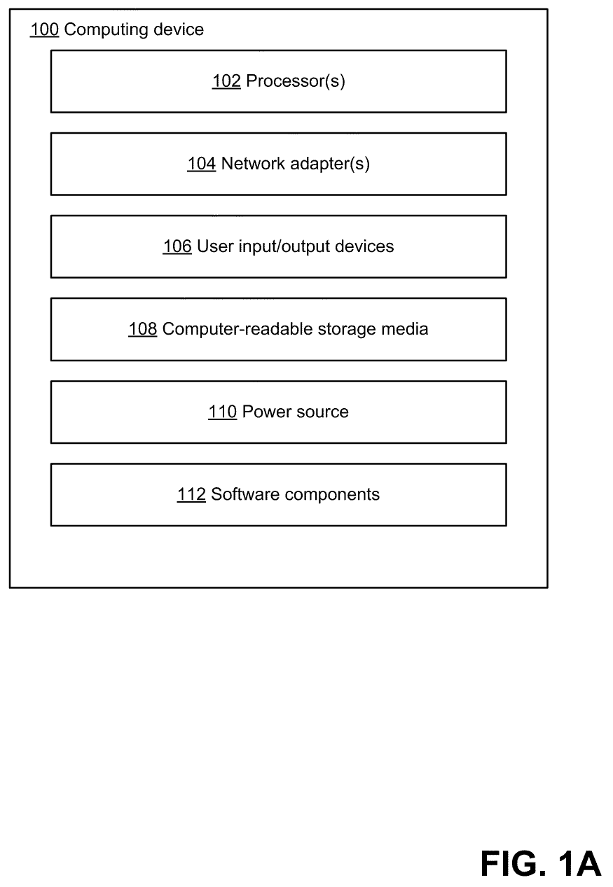

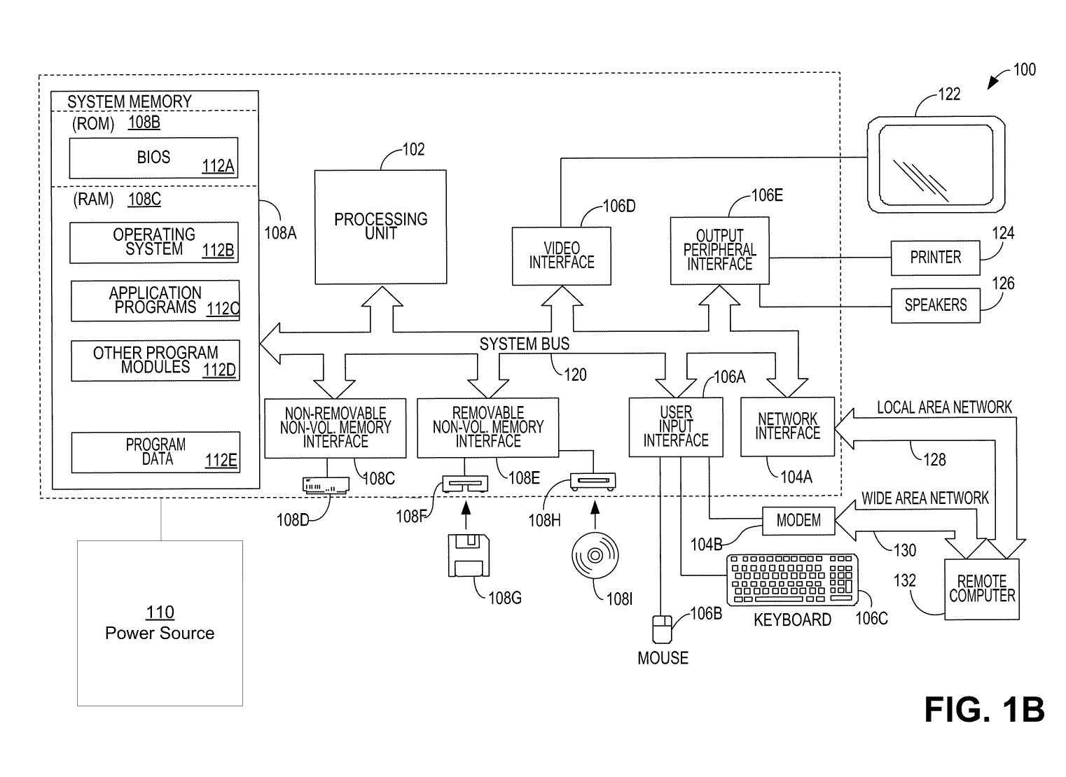

FIG. 1A shows a block diagram of a computing device 100, comprising various components of an exemplary computing device with which some techniques described herein may operate. FIG. 1B shows more specifically one exemplary embodiment of such a computing device 100, including various components of each of the categories of components shown in FIG. 1A as a part of computing device 100. Troubleshooting packages may be developed and used with a common troubleshooting framework such as the one described herein to diagnose, cure, and verify the solution of problems that may arise with any of the components or classes of components shown as a part of computing device 100 in FIG. 1A or 1B.

As shown in FIGS. 1A and 1B, a computing device 100 may include one or more processors or processing units 102. A processor 102 may be a processor chip, or may be any physical or logical processing unit, such as a processing core of a multi-core chip.

Computing device 100 may also include one or more network adapters 104 to enable the computing device 100 to communicate over one or more communication networks. As shown in FIG. 1B, network adapters 104 may include one or more adapters, including a network interface 104A and/or modem 104B as well as any other suitable wired and/or wireless interfaces, for communicating over local and/or wide area networks 128, 130 to a remote computing device 132. Troubleshooting packages may be developed and used by a troubleshooting framework implemented according to techniques described herein to troubleshoot various problems with network adapters 104, including an inability to connect to a local and/or wide area network, an inability to exchange data or certain types of data, an inability to communicate to a particular remote computing device 132, or any other type of problem that a network adapter 104 may experience.

Computing device 100 may include one or more user input/output (I/O) devices 106 to enable a user of a computing device 100 to provide information (e.g., data and/or instructions) to and receive information from the computing device 100 or components of computing device 100. User I/O devices 106 may include any suitable I/O components, including a user input interfaces 106A, such as software components that create and manage user interfaces for a user and hardware components that receive input from peripheral devices and provide the input to other components of the computing device 100. The user I/O devices 106 may also include one or more video interfaces 106D, that may include software and/or hardware components regarding display of user interfaces, and output peripheral interfaces 106E that may include software and/or hardware components to provide output from the computing device 100. User I/O devices 106 may also include peripheral devices connected to the computing device 100, such as a mouse 106B, keyboard 106C, display monitor 122, printer 124, speakers 126, or any other suitable peripheral devices that may provide input to or receive output from computing device 100. Troubleshooting packages may be developed and used by a common troubleshooting framework implemented according to techniques described herein to troubleshoot various problems with user I/O devices 106, including problems with display of a user interface (e.g., wrong colors are being displayed, or the display is blurry or the wrong size), problems with output to a device (e.g., the speakers are not producing sound, or the printer is not printing), or problems receiving input from devices (e.g., the mouse is not moving the cursor, or signals from the keyboard are producing the wrong characters), or any other type of problems that user I/O devices 106 may experience.

Computing device 100 may also include one or more computer-readable storage media 108 to which to write information (e.g., data and/or instructions) or from which to receive information. Computer-readable storage media may be any suitable storage media, including storage components of the computing device 100 such as system memory 108A that may be one or more types of Random Access Memory (RAM) 108C and/or one or more types of Read-Only Memory (ROM) 108B. Storage components of the computing device 100 may also include non-removable, non-volatile memory interfaces 108C, including one or more hard disk drives 108D or other types of non-volatile memory. Computer-readable storage media 108 may also include one or more removable memory interfaces 108E, such as interface components 108F and 108H for receiving and communicating with removable storage media such as disks 108G and 108I. Troubleshooting packages may be developed and used by a common troubleshooting framework implemented according to techniques described herein to troubleshoot various problems with computer-readable storage media 108, including problems with writing information to or reading information from the computer-readable storage media, problems restoring or backing up information stored on the media, problems with lost or corrupted information that had been stored on the media, or any other type of problem that a computer-readable storage medium may experience.

Computing device 100 may also include a power source 110, such as a battery and/or circuitry to receive an external A.C. power signal. Troubleshooting packages may be developed and used by a common troubleshooting framework implemented according to techniques described herein to troubleshoot various problems with a power source 110, such as problems with battery life, including problems with computing device 100 drawing more power than necessary or problems with a battery not charging fully or correctly, or any other type of problem that a power source may experience.

Computing device 100 may also include various software components 112. Software components 112 may include system software components and application software components, or any other suitable type(s) of software components. For example, software components 112 may include a Basic Input/Output System (BIOS) 112A for the computing device 100, an operating system 112B, one or more application programs 112C, other program modules 112D, such as device drivers, scripts, or other modules, and/or program data 112E relating to one or more other software components. Troubleshooting packages may be developed and used by a common troubleshooting framework implemented according to techniques described herein to troubleshoot various problems with software components 112, such as problems relating to functionality of one or more application programs 112C (e.g., a problem with functionality of a particular program, such as a problem with functionality of a word processing program), or problems with operating system 112B (e.g., problems adding or removing components of computing device 100, or problems operating components of computing device 100), or any other type of problem that may be experienced by a software component of a computing device.

Various components of a computing device and problems those components may experience for which troubleshooting packages may be developed have been described. It should be appreciated, however, that these components and problems are merely illustrative of the types of components/problems for which a common troubleshooting package operating according to techniques described herein may provide troubleshooting functionality. Troubleshooting packages may be developed for any suitable computing device including any suitable components, and for any suitable problem(s) that may be experienced by those components. Embodiments of the invention are not limited to operating with any particular components or problems.

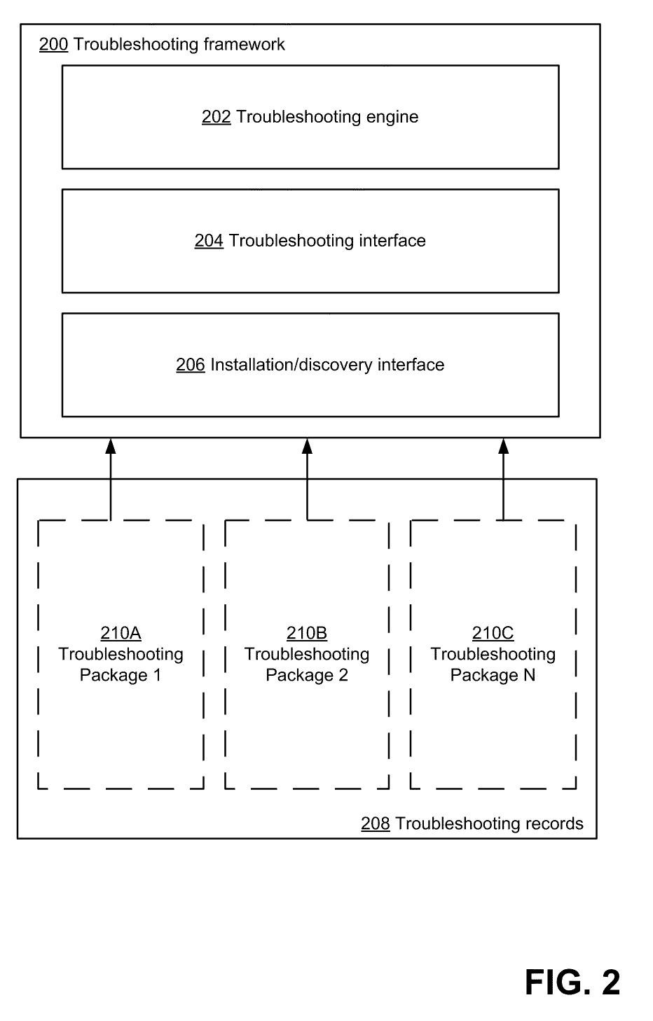

FIG. 2 shows a block diagram of one exemplary implementation of a troubleshooting framework, including various components of the exemplary framework. It should be appreciated, however, that the implementation shown in FIG. 2 is only illustrative, and that a troubleshooting framework operating according to the principles described herein may be implemented in any suitable manner.

The troubleshooting framework 200 shown in FIG. 2 is a common troubleshooting framework that provides the ability to execute functions to carry out troubleshooting processes described by troubleshooting packages. These troubleshooting packages, in some embodiments of the invention, may be implemented in a declarative manner. A declarative troubleshooting package may implement troubleshooting techniques by describing what functionality is to be enabled and carried out by a troubleshooting tool, rather than how the functionality is carried out. For example, rather than implementing its own user interface and including computer-executable instructions to generate the user interface, a troubleshooting package may describe (e.g., list, or identify) display elements like images or text that should be included in a troubleshooting user interface. The troubleshooting framework 200, in reviewing and “executing” a troubleshooting package to carry out a troubleshooting process, may implement the functionality described in the package by executing functions to create a user interface that includes the display elements described by the troubleshooting package. Exemplary implementations of troubleshooting packages are described in greater detail below.

Accordingly, in the embodiment of the invention shown in FIG. 2, a troubleshooting framework 200 may include one or more functionality facilities such as a troubleshooting engine 202 to review and execute a troubleshooting package. The troubleshooting engine 202 may include any suitable functionality, including knowledge about the structure and format of troubleshooting packages that may be provided to the troubleshooting framework 200. Having knowledge of the structure and format, the troubleshooting engine 202 may therefore be adapted to review a troubleshooting package to determine the manner in which the troubleshooting package is to solve problems, and then execute functions according to the directions of the troubleshooting package.

In embodiments of the invention which operate with a declarative troubleshooting package, a troubleshooting package may include a description of one or more tasks to be completed. Upon receiving an indication that a package is to be executed, the troubleshooting engine 202 may review the contents of the package to identify the task(s) and then may select and execute functions from a library of troubleshooting functions to complete that task. The tasks described in the troubleshooting package may be any suitable tasks relating to a troubleshooting tool and/or troubleshooting process, including tasks for diagnosing, resolving, and verifying resolution of a problem. When carrying out a diagnostic phase of a troubleshooting process, then, the troubleshooting engine 202 may review a task that is described by the troubleshooting package as part of a diagnostic process, then execute functions that enable the accomplishment of that task, thereby carrying out the diagnostic process according to the description in the package.

In some implementations, a troubleshooting engine 202 may additionally or alternatively execute instructions that are a part of the troubleshooting package. For example, a troubleshooting package may include one or more scripts or other types of computer-executable instructions. The troubleshooting package may then direct, as part of a description of a task to be accomplished, the execution of the instructions. When the troubleshooting engine 202 reviews the troubleshooting package, the troubleshooting engine 202 may recognize the direction to execute the instructions, retrieve the instructions from the package, and execute the instructions as a part of carrying out the task described by the troubleshooting package.

Accordingly, in embodiments of the invention that operate with declarative troubleshooting packages, a troubleshooting framework may not be adapted to carry out any troubleshooting functions entirely on its own, but rather may execute functions to carry out tasks described by a troubleshooting package to troubleshoot a problem being experienced by a computing device.

Troubleshooting framework 200 may also include a troubleshooting interface 204 that may include any suitable user interface for providing information to and receiving information from a user, and/or any suitable interface for providing information to and receiving information from other components of a computing device (e.g., an Application Programming Interface (API)). The troubleshooting interface 204 provides the ability to interact with the troubleshooting framework 200, and may provide a common interface for all troubleshooting packages. For example, for each troubleshooting package used with the troubleshooting framework, the troubleshooting interface 204 may have a common “look and feel” to its user interface such that a user may become accustomed to using the interface, rather than having to learn a new interface for each troubleshooting package. Similar to the execution of functions as described above in connection with troubleshooting engine 202, the troubleshooting framework 200—through, for example, the troubleshooting interface 204—may be adapted to review a troubleshooting package and create/render a user interface for a troubleshooting tool according to a description of an interface, or one or more display elements to be included in the interface, that is included in the troubleshooting package.

For example, a troubleshooting package may include a description of a particular component of a user interface, such as a drop-down menu of options by which a user may provide input. The description can take any suitable form, such as a listing of options and an identification of the drop-down list display element. The troubleshooting interface may review the listing and the identification, and render a user interface that includes a drop-down list including those options. By including only a reference to the drop-down menu and the options to be included in it rather than instructions on how to render the drop-down menu itself, and relying on the common troubleshooting interface 204 to render the drop-down list, a distributor of troubleshooting packages may be freed from the burden of knowing how to render a drop-down menu. Further, if the troubleshooting interface 204 renders all such drop-down menus based on similar descriptions in multiple troubleshooting packages, each user interface generated for the multiple troubleshooting packages will have a similar drop-down menu, and there will be a common “look and feel” to each troubleshooting tool produced by the troubleshooting framework, allowing a user to become accustomed to the use of troubleshooting tools.

In other cases, the troubleshooting package may alternatively or additionally include actual display elements that are to be included in a user interface. For example, a distributor of a troubleshooting package may include a logo for the distributor, and the troubleshooting package may include in the description of the user interface a reference to the logo, as well as a description that it be included in the interface. The troubleshooting interface 204 may review the troubleshooting package, and when rendering the user interface according to the description retrieve an image file of the logo from the package, and include it in the user interface.

In addition to providing an interface for troubleshooting packages, the troubleshooting interface 204 may also provide an interface for the troubleshooting framework 200. For example, the interface 204 may include an interface by which troubleshooting packages may be selected to be executed, such as by a user interacting with a user interface.

Further, in some implementations, such as those operating with declarative troubleshooting packages, the troubleshooting interface 204 may support a number of user interface elements (e.g., drop-down menus) that may be used in a user interface, and the troubleshooting package may describe which elements are to be displayed to a user at a particular time or step of a troubleshooting process. The troubleshooting interface 204 may then review the description contained within the troubleshooting package (including the listing of elements) and render a user interface for a troubleshooting tool using those elements. As before, the troubleshooting interface 204, in some embodiments of the invention, may not be adapted to perform any tasks or functions on its own (e.g., rendering a user interface), but rather may execute functions as directed by a troubleshooting package to create a user interface for the troubleshooting package. The troubleshooting interface 204 may also render any other suitable interface in a similar manner, such as exposing an API that accepts information or includes functions as directed by a troubleshooting package.

Some embodiments of a troubleshooting framework 200 may also include an installation/discovery interface 206, by which troubleshooting packages may be added to or removed from the troubleshooting framework 200. This may occur in any suitable manner. The installation/discovery interface 200 may be adapted to add a troubleshooting package during an install process, such as during an install of new functionality (e.g., an installation of a new application program that includes a troubleshooting package) or during an update of functionality (e.g., an update of an operating system that includes a new troubleshooting package for the operating system). The installation/discovery interface 206 may also be adapted to search for and install appropriate troubleshooting packages. For example, the interface 206 may detect that a new component has been added to a computing device (e.g., a new application program, or new hardware) and may search for a corresponding troubleshooting package and add it to the troubleshooting framework 200. Additionally or alternatively, the interface 206 may be adapted to search for and install a troubleshooting package in response to user input. For example, a user may input to the interface 206—such as by a user interface rendered by troubleshooting interface 204—a description of a problem being experienced by the user, such as a keyword associated with the problem. The interface 206 may then search for and retrieve one or more packages associated with the problem/description, and present them to the user to be used to solve the user's problem. A troubleshooting package may be added to the troubleshooting framework upon being searched for by the interface 206, or may be added upon being selected by a user.

It should be appreciated, however, that some embodiments of the invention may not include any kind of installation and/or discovery components, as embodiments of the invention are not limited in this respect. An interface such as installation/discovery interface 206 may be advantageous in some environments for providing troubleshooting packages that may be used to troubleshoot problems, but in other environments packages may not be provided at all (e.g., all packages may be pre-installed) or troubleshooting packages may be provided in any other way.

In addition to the various components of the troubleshooting framework 200—examples of which are shown in FIG. 2 as troubleshooting engine 202, troubleshooting interface 204, and installation/discovery interface 206—the troubleshooting framework 200 may also maintain one or more sets of troubleshooting records 208. Troubleshooting records 208 may include any suitable information about the status or properties of troubleshooting framework 200, and may, as shown in FIG. 2, include one or more troubleshooting packages 210A, 210B, and 210C. In some embodiments, troubleshooting records 208 may also include statistics about one or more of the troubleshooting packages, such as statistics about a success or failure of the troubleshooting package at diagnosing and solving problems.

Troubleshooting records 208 may be formatted in any suitable manner to contain any suitable information. In some implementations, troubleshooting records 208 may be implemented in part or in whole as one or more Extensible Markup Language (XML) data structures, and each troubleshooting package may be stored at least in part as an XML data structure. It should be appreciated, however, that this implementation is only illustrative of the various ways in which records 208 may be maintained, and that embodiments of the invention are not limited to maintaining records 208 in any particular manner.

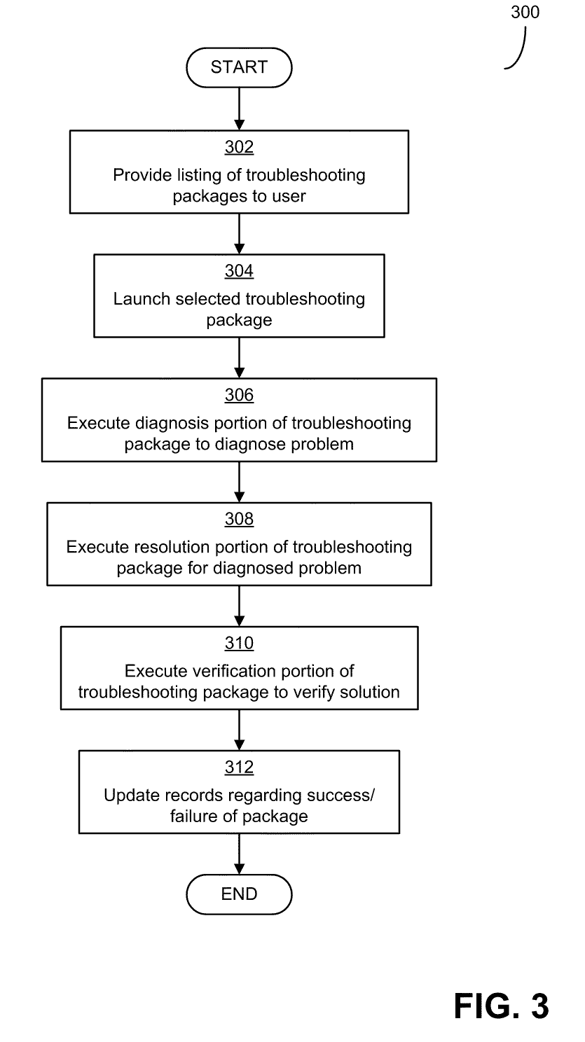

A troubleshooting framework operating according to the principles described herein—such as troubleshooting framework 200 of FIG. 2—may carry out a troubleshooting process in any suitable manner. In some implementations, the manner in which a troubleshooting process is carried out may be dependent on the manner in which troubleshooting packages are implemented, and may vary between packages. FIG. 3 shows one exemplary process 300 that may be followed by a troubleshooting framework (e.g., by functionality facilities of the framework, like a troubleshooting engine) while executing a troubleshooting package. It should be appreciated, however, that any suitable process may be implemented to carry out a troubleshooting process, as embodiments of the invention are not limited in this respect.

Process 300 of FIG. 3 begins in block 302, in which a listing of one or more potential troubleshooting packages is presented to a user for selection. The listing may be provided in block 302 as a listing of some or all available troubleshooting packages, from which a user may select one to use in troubleshooting a particular problem. Available troubleshooting packages may include packages installed on a computing device and/or packages available for installation on or download to a computing device from a remote computer (e.g., a web server).

In some implementations, the listing of block 302 may be provided without input, as a listing of potential troubleshooters from which one may be selected to troubleshoot a particular problem. In other implementations, the listing may be provided in response to some indication of a problem to be solved. This indication may be any suitable information related to a particular problem. For example, upon detection in an application program of a problem with the application program (e.g., a web browser detecting that the computing device does not have an open connection to a computer network), the application program may provide the troubleshooting framework with information about the problem and request that it display a listing of one or more troubleshooting packages that may be used to solve the problem. As another example, a user may provide input to the troubleshooting framework describing a problem, and the troubleshooting framework may provide the listing of potential troubleshooting packages that match that problem. In such implementations, a user may be provided with an interface by which the user can input a description of the problem, such as a question or keywords or any other suitable description.

Regardless of how it is provided, the listing provided in block 302 may include any suitable information about each of the packages in the listing. For example, the information about each of the packages may include a description of the problem the package solves, root causes of the problems, a description of the solution, and/or any other information.

In block 304, upon selection of a troubleshooting package from the listing provided in block 302, the selected troubleshooting package is launched. Launching a troubleshooting package may involve any suitable action, including rendering a user interface according to information contained within the troubleshooting package. In embodiments of the invention which operate with declarative troubleshooting packages, the package may include a description of one or more display elements to be included in user interface, and launching the package in block 304 may include identifying those elements described in the package and rendering a user interface that includes those elements. Launching the package in block 304 may also include any suitable initialization actions for the troubleshooting package, which may vary based on the implementation and functionality of the package.

In block 306, the troubleshooting framework may begin using the troubleshooting package to carry out a troubleshooting process to diagnose, resolve, and verify resolution of a problem being experienced by a computing device. As described above, in embodiments of the inventions, the troubleshooting framework may be adapted to execute functions based on information contained in the troubleshooting package, such as information describing tasks that are to be carried out. Accordingly, in block 306, the troubleshooting framework may begin reviewing and executing functions described by the diagnosis portion of the troubleshooting package. As discussed above, in embodiments of the invention which operate with declarative troubleshooting packages, the diagnosis portion of the troubleshooting package may include a description of one or more tasks to be carried out to diagnose the problem that is being experienced and that the troubleshooting package is adapted to solve.

Diagnosing the problem may include determining whether the problem is being caused by any of one or more root causes known to the troubleshooting package. For example, if a user having difficulty connecting to a particular web site launches a troubleshooting tool for Internet connectivity problems, the troubleshooting package associated with that troubleshooting tool—i.e., the troubleshooting package executed by the troubleshooting framework to provide the troubleshooting tool—may identify that the root cause is one of: an Ethernet cable is not plugged in to the computing device or there are no wireless networks in range, the computer is not connected to a network (e.g., does not have an Internet Protocol (IP) address), software on the computing device (e.g., a firewall) is blocking the connection, or any other cause.

In some implementations, the diagnosis portion of the declarative troubleshooting package may include a description of one or more tasks to be carried out, and the troubleshooting framework may interpret the description and perform one or more functions. For example, the description may include prompting a user for input via a user interface (e.g., “Is there an Ethernet cord plugged in to this device?”) or performing one or more functions automatically (e.g., testing to determine whether any network interface is connected to a network). In other embodiments, the troubleshooting package may additionally or alternatively include computer-executable instructions—for example, scripts—that are provided to the troubleshooting framework for execution. These computer-executable instructions may include functions to be executed as part of a diagnostic phase of a troubleshooting process to determine the existence or non-existence of one or more root causes of a problem.

If the troubleshooting framework determines, while carrying out tasks and executing functions as instructed by the diagnosis portion of the troubleshooting package, that one of the root causes of the problem is present on the computing device—and therefore may be causing the problem—the troubleshooting framework may then in block 308 execute a resolution portion of the troubleshooting package to resolve the problem. The resolution portion of the package may instruct the troubleshooting framework to carry out one or more tasks to resolve the root causes of the problem identified in block 306. For example, if a computing device could not access a remote computer over the network, and the root cause identified is that the computing device is not connected to a network, then the resolution portion of the package may include instructions to connect to a network. As above, the resolution portion of the troubleshooting package may include instructions in any suitable form, including in the form of a description of one or more tasks that may be interpreted by the troubleshooting framework such that one and/or more functions are executed or computer-executable instructions (e.g., a script) that may be provided to the troubleshooting framework for execution.

In block 310, once the resolution portion of block 308 is complete, the troubleshooting framework may execute a verification portion of a troubleshooting framework to carry out one or more tasks to confirm that the root cause and problem identified in block 306 was solved in block 308. For example, if the problem was that a computing device could not access a remote computer over the network, then the verification portion of the package executed in block 308 may include attempting to connect to the remote computer over the network. As above, the verification portion of the troubleshooting package may include instructions in any suitable form, including in the form of a description of one or more tasks that may be interpreted by the troubleshooting framework such that one and/or more functions are executed or computer-executable instructions (e.g., a script) that may be provided to the troubleshooting framework for execution.

In block 312, the process 300 finishes executing functions of the troubleshooting package and updates records regarding the package, including records on the success/failure of the package. In some implementations, a troubleshooting framework may be adapted to maintain records regarding the effectiveness of troubleshooting packages. These records may be used to enable users to select troubleshooting packages, such as by reporting the effectiveness of packages in the listing provided in block 302. In some embodiments of the invention, these records may be shared, in whole or in part, with other parties, such as other users and/or developers/distributers of the troubleshooting packages, to aid the other parties in selecting and/or improving packages based on effectiveness.

Once the records have been updated in block 312, the process 300 ends.

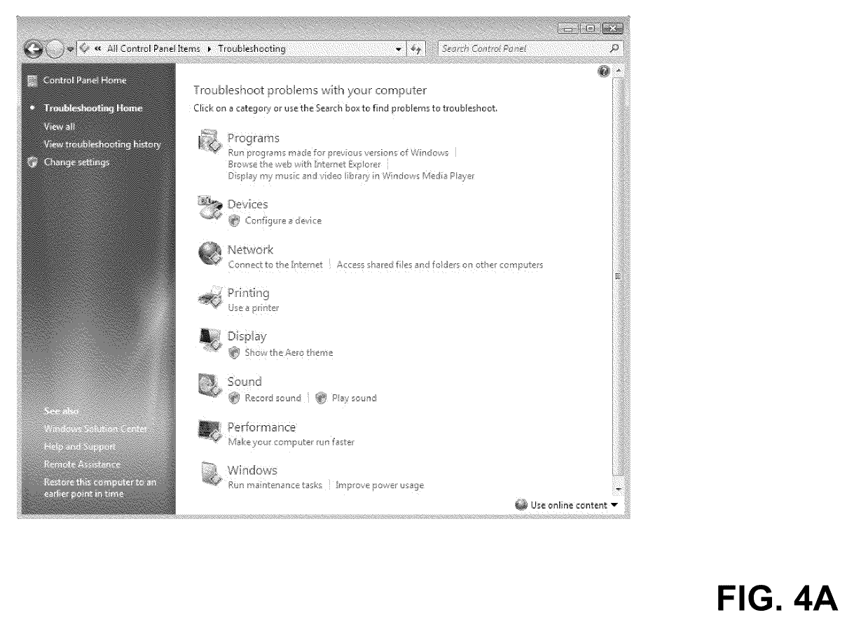

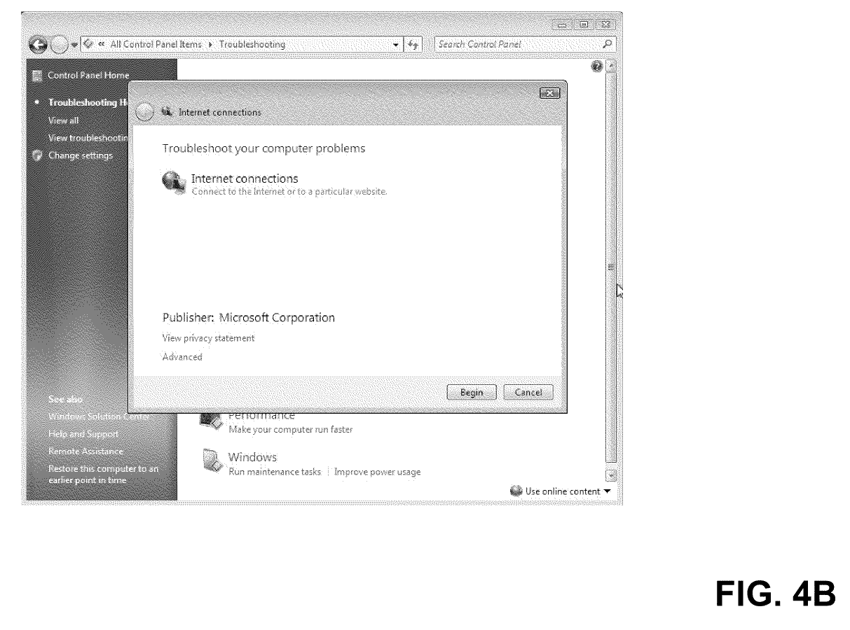

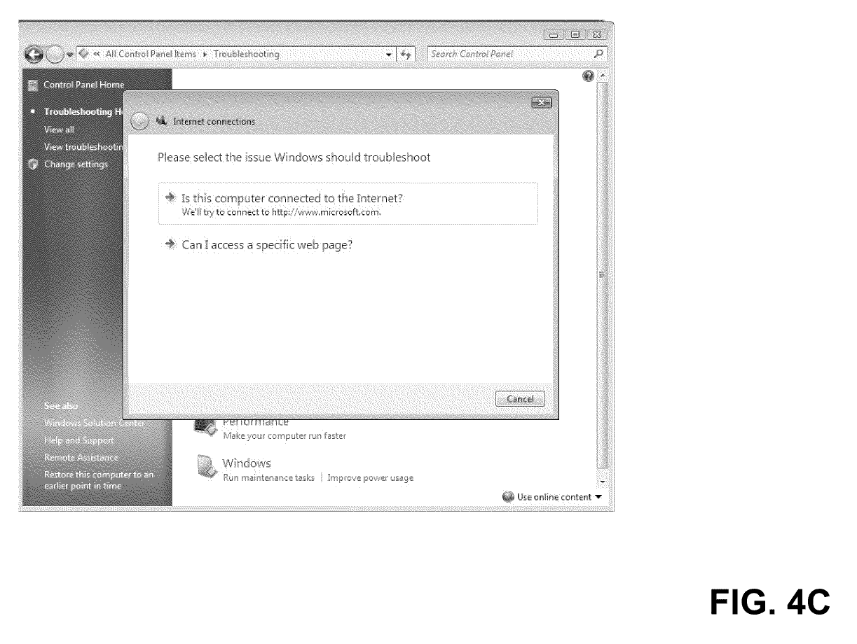

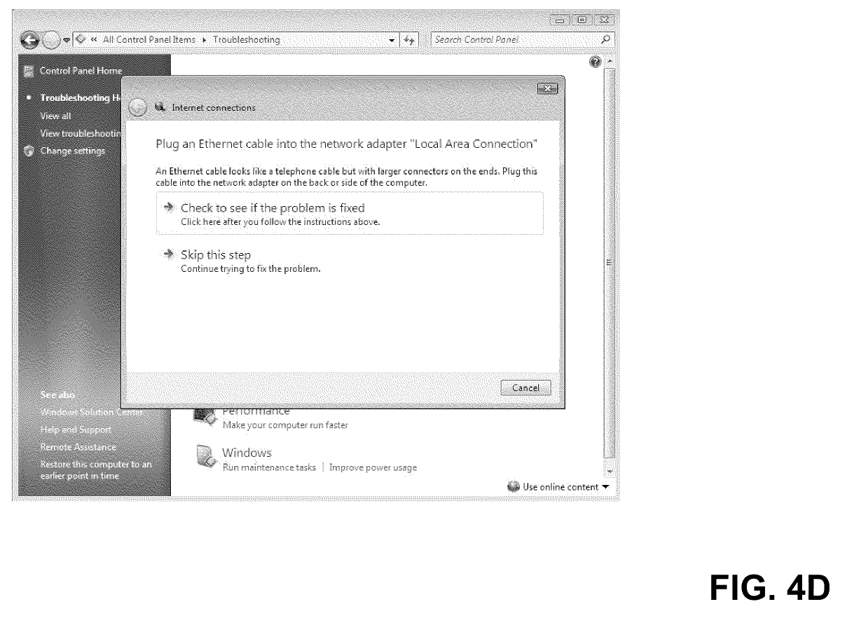

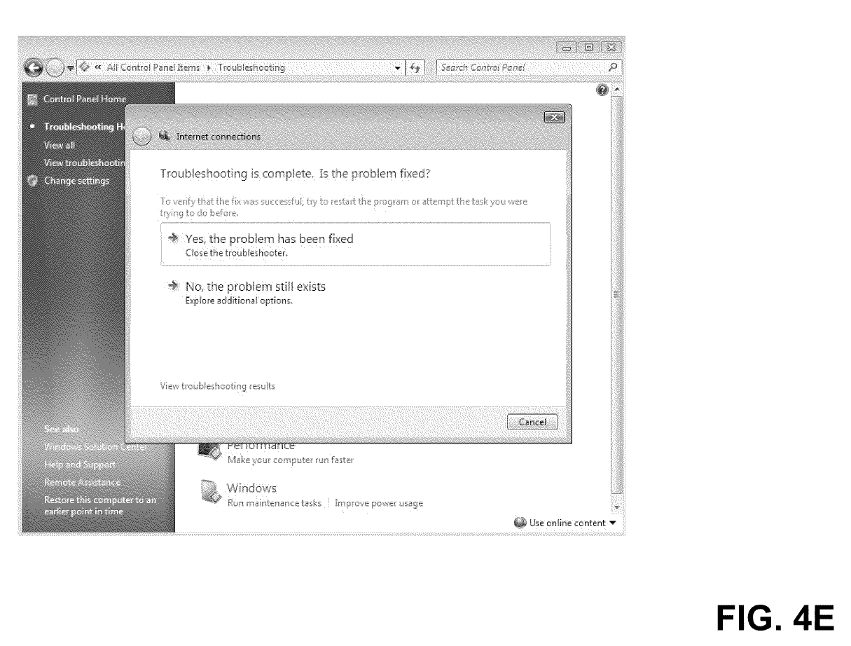

As described above in connection with FIG. 2, a troubleshooting framework may, in some implementations, provide a user interface that is driven by a troubleshooting package and includes display elements as instructed by the troubleshooting package. This interface may be used to provide information to a user, such as regarding a state of the troubleshooting process, as well as receive information from a user, such as input regarding the process. FIGS. 4A to 4E, 5A to 5C, and 6 show examples of a user interface that may be implemented by embodiments of the invention, being driven by different troubleshooting packages according to the instructions and information contained within the packages. It should be appreciated, however, that these user interface images are merely exemplary of the types of user interfaces that may be used and information that may be included in them. Embodiments of the invention are not limited to implementing any particular type of user interface.

Various user interfaces are shown below that may be implemented by some embodiments of the invention. The examples shown are for embodiments of the invention that implement a process like that shown in FIG. 3 for carrying out a troubleshooting process and, accordingly, the user interfaces shown below depict a user experience that may be provided during the troubleshooting process of FIG. 3.

FIG. 4A shows a first image of a user interface for a troubleshooting framework, in which is displayed a listing of available troubleshooting packages. These packages may be installed local to the computing device displaying the user interface and/or may be available for download and installation. As shown in FIG. 4A, in this exemplary user interface the troubleshooting packages are arranged according to topic or subject (e.g., “Programs,” “Devices,” “Network,” etc.) and include short descriptions of the types of problems they may be used to solve (e.g., “Connect to the Internet” or “Use a printer.”)

In FIG. 4B, the user interface shows that a user has selected to troubleshoot a “Network”-related problem, and selected the package for problems with connecting to the Internet. The user is given the ability to “begin” the troubleshooting process and launch the troubleshooting package.

In FIG. 4C, the user interface shows that the framework has begun executing the package by executing the diagnosis portion of the package. As shown in FIG. 4C, the user interface is requesting input from a user to be used in diagnosing the problem which the troubleshooting package is to solve. As discussed above, in some implementations, all or some of the content shown in the user interface of FIG. 4C and figures below may be rendered by a troubleshooting framework according to information in the troubleshooting package, such as information describing the two prompts shown in FIG. 4C. For example, the troubleshooting package may specify that a user is to be shown a prompt, and the prompt is to include the text (i.e., the two questions) shown in FIG. 4C. The troubleshooting framework may then, upon reviewing the troubleshooting package, render a user interface that includes the text. In this way, the troubleshooting package itself may not need to include instructions on how to render a user interface, but rather can rely on the troubleshooting framework to render an interface based on a description, in the package, of what is to be included in the interface.

In FIG. 4D, the user interface shows instructions that are given to a user during a resolution portion of the troubleshooting process, as well as prompts to the user to begin a verification portion of the troubleshooting process and continue the resolution portion. Again, the elements of the user interface shown in FIG. 4D may be rendered based on a description of a user interface and elements of a user interface provided in the troubleshooting package. Further, the troubleshooting framework may be aware that it is to display a user interface relating to the resolution portion of a troubleshooting process based on an outline and description of the troubleshooting process contained in the troubleshooting package. As discussed above, troubleshooting a problem may involve any number and type of actions, including, as shown in FIG. 4D, instructing a user to carry out actions like “plug an Ethernet cable” into a computing device. Troubleshooting may also involve automated functions taken by a computing device, or any other action.

In FIG. 4E, a verification portion of the troubleshooting process is shown. In FIG. 4E, a user is prompted for whether the problem has or has not been fixed. Again, as discussed above, the troubleshooting framework may be aware that it is to execute a verification portion of a troubleshooting process based on a description of the troubleshooting process provided in the troubleshooting package, and may be aware that it is to render a particular user interface containing particular user interface elements based on a description of a user interface contained in the troubleshooting package. A verification portion may comprise any suitable process, including a prompt to a user as shown in FIG. 4E, or an automatic detection process associated with the problem (e.g., for a network connection problem, attempting to connect to a web site).

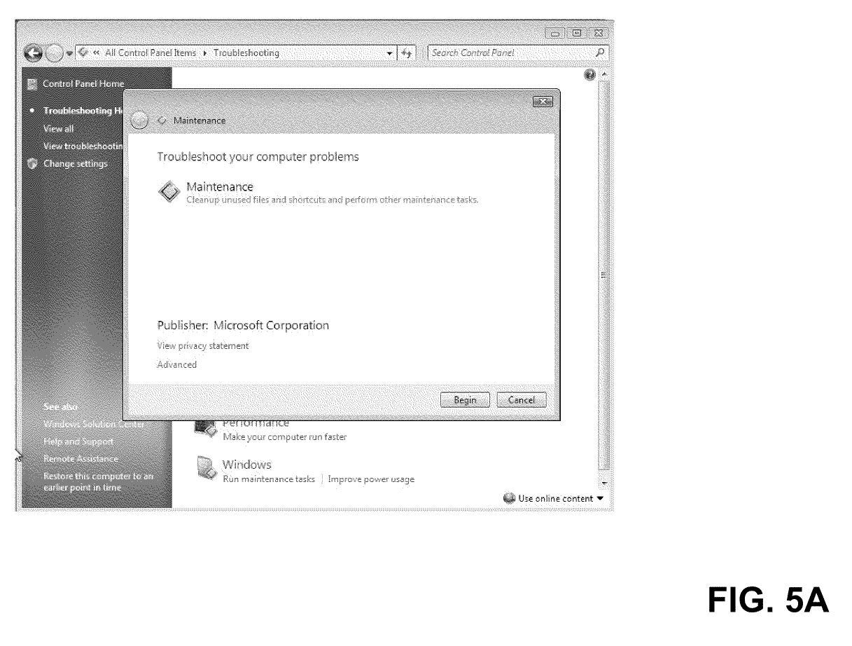

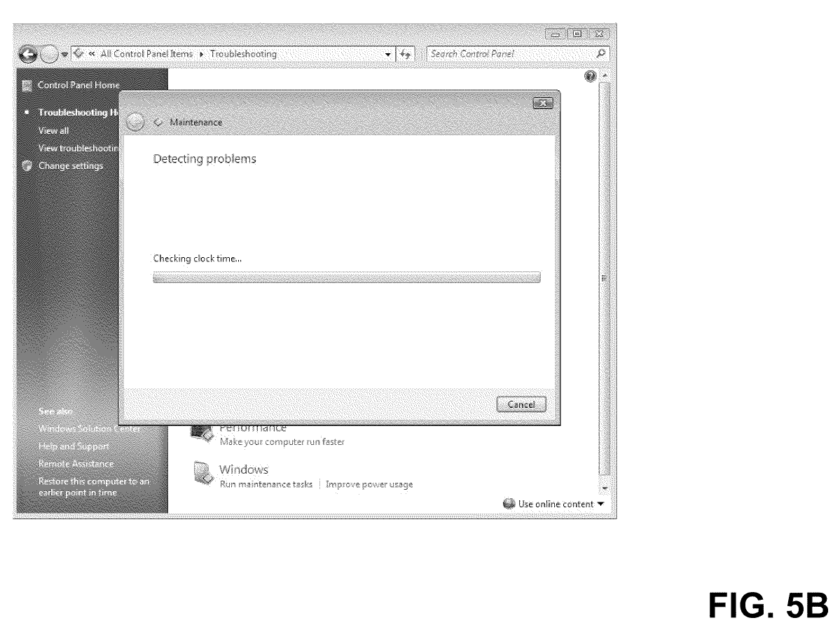

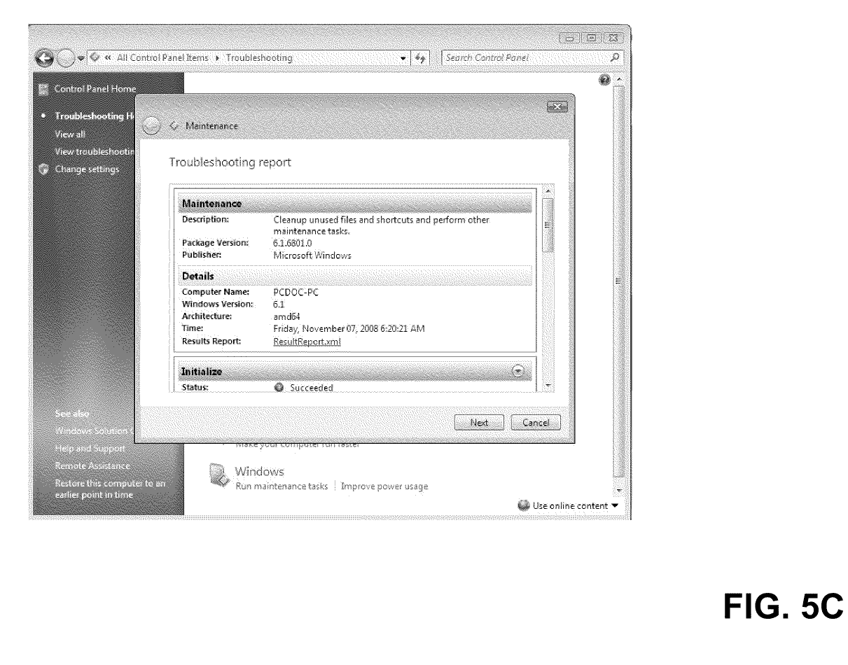

FIGS. 5A to 5C show another troubleshooting package that may be used to drive a troubleshooting framework to perform a troubleshooting process, and a user interface rendered by the framework according to instructions of the package. FIG. 5A, as FIG. 4B, shows a selection of a user of a maintenance troubleshooting package to “clean up unused files and shortcuts and perform other maintenance tasks” that may be used to improve general performance of a computing device rather than solve any particular problem. The interface shown in FIG. 5A also allows a user to “begin” or launch the package.

In FIG. 5B, the user is shown a progress bar and a summary of a process to perform the general maintenance of the troubleshooting package, as part of a diagnosis portion of a troubleshooting process. As part of “detecting problems” automatically—as opposed to the input requested from the user in the example of FIGS. 4A to 4E—the troubleshooting package instructs the troubleshooting framework to perform a function to check the clock time to ensure it is accurate. This may be done in any suitable manner, such as by requesting an update from a time server and comparing that to the current system time and/or using that as the system time. Other tasks may also be automated, both for the general maintenance troubleshooting package shown in FIGS. 5A to 5C, and other packages.

In FIG. 5C, a detailed report is generated for display to a user regarding the actions taken by the package and the outcomes of those actions. The report also includes details on the package and on properties of the computing device on which it was run, as shown in FIG. 5C. As discussed above, this information may be stored and used to measure effectiveness of a particular package and may be shared with other users and computing devices, as well as the developer/distributor of the package, to enable others to make decisions regarding the effectiveness of the package.

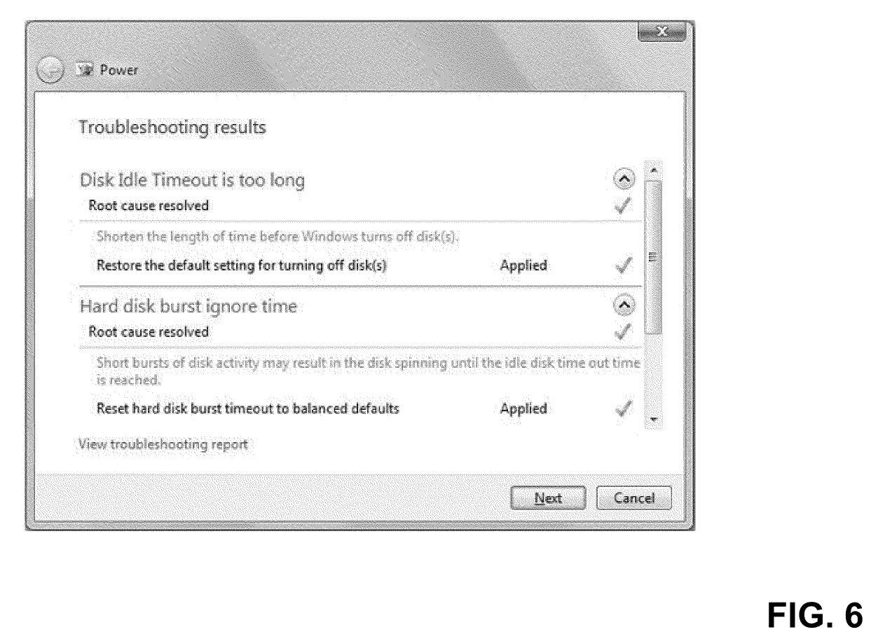

FIG. 6 shows another example of a troubleshooting report that shows more detailed results of actions taken by a troubleshooting package. In this example, a power troubleshooting package (i.e., a troubleshooting package for power-related issues) took several actions to improve the power efficiency of a device, for example, to extend the battery life of a device. As shown in FIG. 6, the package restored default settings for a hard disk idle timeout and hard disk burst ignore time, which may include lowering each of these times to ensure that the hard disk spends less time spinning and, accordingly, less time expending energy.

The images shown in FIGS. 4A to 4E, 5A to 5C, and 6 show various ways in which a troubleshooting framework may render a user interface while carrying out a troubleshooting process as directed by a troubleshooting package. Several exemplary interfaces were shown, and several exemplary tasks and functions were shown being carried out by the troubleshooting interface. It should be appreciated, however, that these examples are only illustrative, and that embodiments of the invention may operate in any suitable manner. It should be further appreciated that embodiments of the invention are not limited to operating with any particular troubleshooting package or troubleshooting packages that are implemented in any particular way, and that troubleshooting packages may be implemented in any suitable manner to direct the operations of a troubleshooting framework.

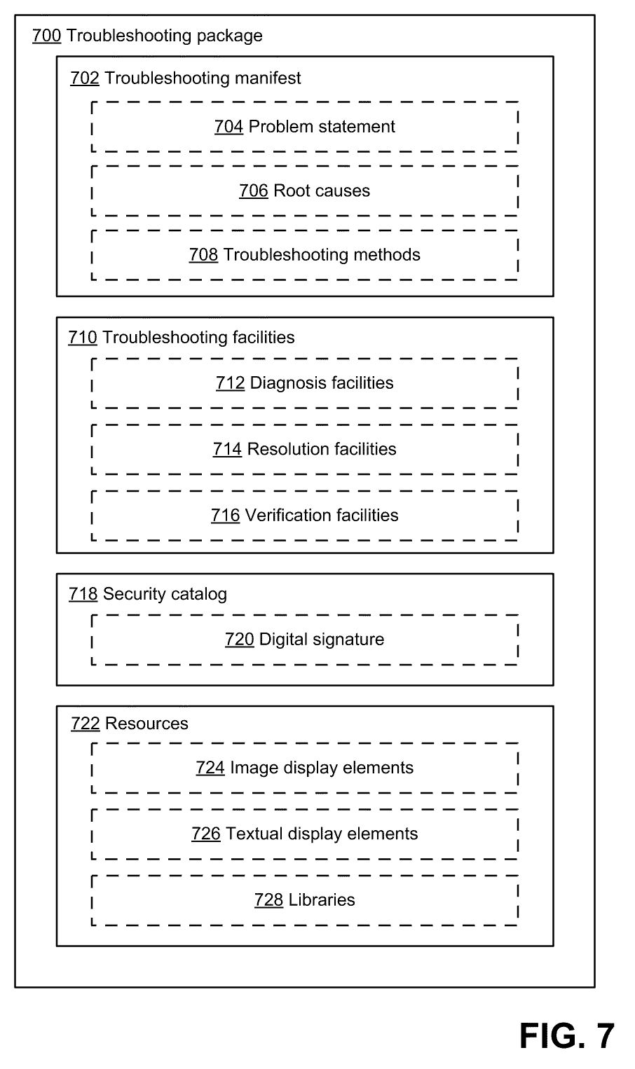

FIG. 7 shows a block diagram exhibiting the structure of one exemplary implementation of a troubleshooting package that may be used to direct the operations of a troubleshooting framework. While the troubleshooting package 700 of FIG. 7 is shown including various components, it should be appreciated that these components are merely illustrative, and that FIG. 7 is not intended to be a depiction of necessary components, nor a comprehensive depiction of components of a troubleshooting package.

In some implementations, at least some of a troubleshooting package like troubleshooting package 700 may be implemented as an Extensible Markup Language (XML) file, and examples are given below where the package is implemented as an XML file. It should be appreciated that a package 700 may be implemented in any suitable manner, and that XML is just one illustrative example.

As shown in FIG. 7, troubleshooting package 700 comprises a troubleshooting manifest 702. Troubleshooting manifest 702 may include a description of the contents and purpose of the package 700, such that it may be consulted for information relating to the package 700 itself. Manifest 702 may include any suitable information about the contents and purpose of the package 700. As shown in FIG. 7, the manifest may, in some implementations, include information regarding the problem(s) to be solved by the package 700, which may be in the form of problem statement 704, as well as one or more root causes 706 of the problem described in problem statement 704. Other contents of the troubleshooting package 700 may relate to one or both of the problem statement 704 and root causes 706, such that some other contents of the package 700 may be associated with a particular problem and/or particular root cause. For example, for each root cause in root causes 706, the package 700 may include diagnosis facilities (described below) for diagnosing whether the root cause exists.

Troubleshooting manifest 702 may also include information related to troubleshooting methods 708. The troubleshooting methods 702 may include any suitable information that may be used in a troubleshooting process. For example, methods 708 may include an outline or description of a process to be taken in diagnosing and solving the problem(s) referenced in the problem statement 704; in other words, the methods 708 may describe and outline a flow of a troubleshooting process that is to be followed by a troubleshooting package, as well as various tasks or operations that are to be completed or carried out during the process. This flow contained in the troubleshooting package may provide direction to the troubleshooting framework. When executing the troubleshooting package, the troubleshooting framework may review the methods 708 to determine one or more functions to execute to carry out the troubleshooting process. In some implementations, the methods 708 may include a reference to one or more other files, or other portions of the troubleshooting manifest 702, containing the outline or description, and/or containing functions to be executed by a troubleshooting framework (e.g., a script). For example, the troubleshooting manifest 702 may include descriptions of display elements to be included in a user interface, and the troubleshooting methods 708 may include references to the display elements to be included in a user interface to be displayed to a user as part of a troubleshooting process.

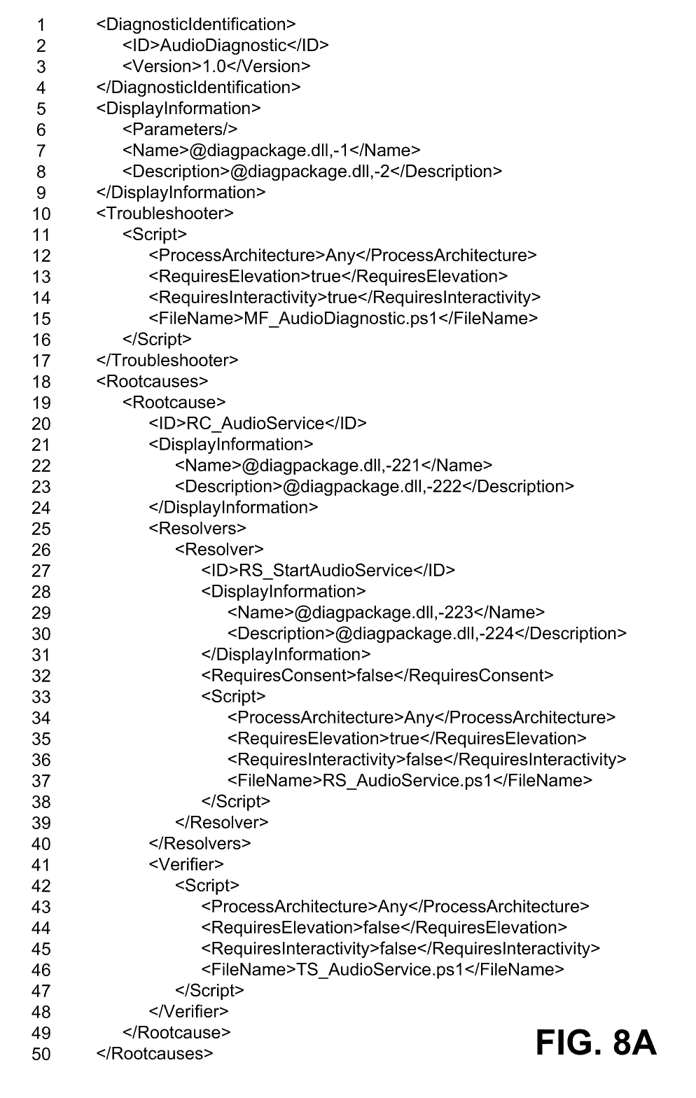

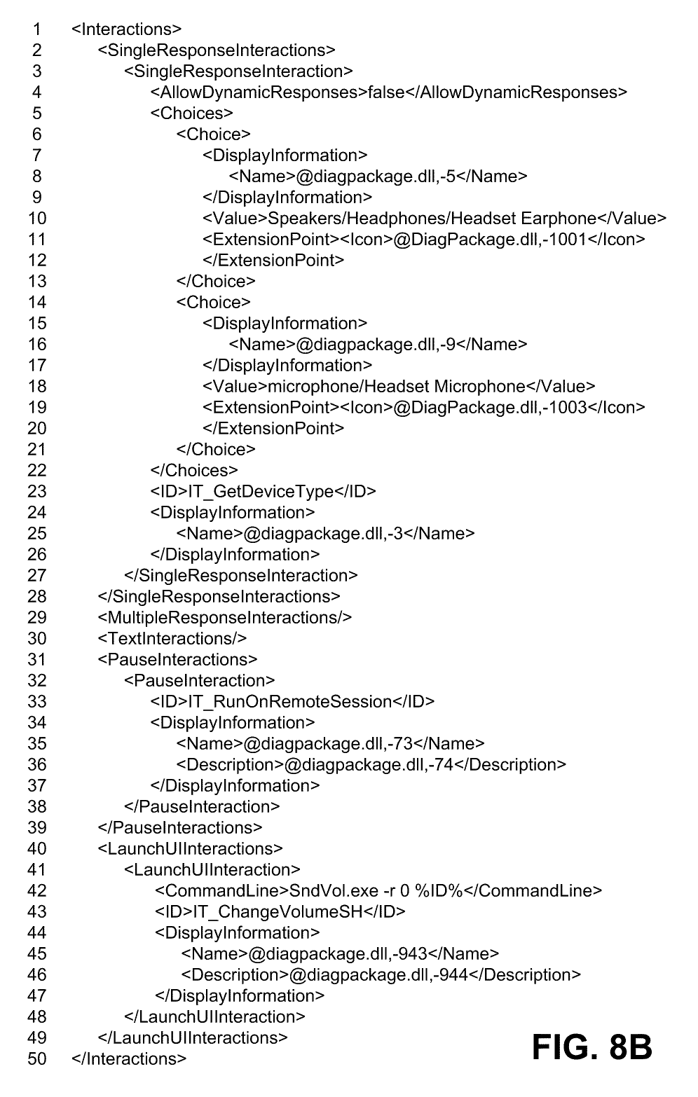

FIGS. 8A and 8B show one example of a format of a troubleshooting manifest 702, and information that may be included in a troubleshooting manifest 702. In the example of FIGS. 8A and 8B, the troubleshooting manifest 702 is implemented as an XML file, but it should be appreciated that this is merely one example of a way in which information may be structured inside a troubleshooting manifest, and that other ways are possible.

As shown in FIG. 8A, the troubleshooting manifest 702 may include information about the troubleshooting package 700, such as identification and version information, as well as name and description information to be displayed in a user interface (e.g., the user interface shown in FIG. 4A, including names and descriptions of available packages). This information is shown in FIG. 8A in lines 1-9, and may be formatted in any suitable manner, examples of which are shown therein. For example, the information may be contained in the manifest 702 itself, such as in lines 2 and 3 where the “ID” and “Version” fields are respectively populated with the values “AudioDiagnostic” and “1.0.” Alternatively, the information may be provided in manifest 702 as a reference to another file and a location in that file, such as is shown in lines 7-8 that include a reference to the Dynamically Linked Library (DLL) file diagpackage.dll. This reference may be used for any suitable information, but may be done in particular for display elements. This may be done to ensure that the manifest 702 may be easily updated for display in various languages, such as by changing the contents of the DLL file rather than changing all the values in a manifest 702.

FIG. 8A also shows, in lines 10-17, a reference to a troubleshooter that may be used in the diagnosis portion of a troubleshooting process. The troubleshooter of FIG. 8A is contained within another file, identified at line 15 as “MF_AudioDiagnostic.ps1.” The “PS1” extension identifies the file as a Windows PowerShell® script file—using PowerShell® scripts techniques available from the Microsoft Corporation of Redmond, Wash.—that may provide functions to the troubleshooting framework to execute, but it should be appreciated that in other implementations the troubleshooter may include a description of tasks to be completed that may be interpreted by a troubleshooting framework. It should be further appreciated that PowerShell® is only one example of a scripting technology that may be implemented in a troubleshooting package, and that other computer-executable instructions (whether scripts or other instructions) may be used in embodiments of the invention. Lines 10-17 of FIG. 8A also show various properties of the diagnosis portion of the troubleshooting process, such as that the troubleshooter requires interactivity with a user (line 14) and needs “elevation” (line 13) to administrator-level privileges. These properties may cause the troubleshooting framework to execute one or more functions, such as enabling and rendering a user interface for the package to allow for interactivity and prompting a user for an administrator password to enable the administrator-level privileges.

Lines 18-50 of FIG. 8A show a listing of root causes that may cause the problem(s) the troubleshooting package is designed to solve, as well as various information related to those root causes and processes for solving them. For example, lines 20-24 of FIG. 8A describe a root cause of a problem with the audio system of a computing device, such as that an audio service of the computing device is not enabled. A name is given for the root cause, as well as a description, in lines 22-23.

As discussed above, associated with each root cause may be outlines of a process flow, or descriptions of particular tasks and operations that are to be carried out during a troubleshooting process, for resolving the root cause in a resolution portion of a troubleshooting process, as well as verifying the solution in a verification portion of the troubleshooting process. Lines 25-40 and 41-48, respectively, contain information associated with the resolution portion and the verification portion of a troubleshooting process associated with the root cause identified in lines 20-24. In the “Resolvers” portion of the manifest 702, a resolver is identified that will solve the root cause—namely, starting the audio service. This resolver (“RS_StartAudioService”) is described, and properties of the resolver are described, and reference is made to a PowerShell file (“RS_AudioService.ps1”) that implements the resolver. If a troubleshooting framework, upon executing the troubleshooter MF_AudioDiagnostic.ps1 during the diagnosis phase of a troubleshooting process, identifies that the root cause of the audio problems is that the audio service is disabled, then the troubleshooting framework may then execute the resolver RS_AudioService.ps1 to start the audio service and resolve the problem. Similarly, a verifier is identified in lines 42-47 to verify, upon completion of the resolving portion of the process, that the problem is solved by executing the script(s) contained in “TS_AudioService.ps1.” As above, it should be appreciated that PowerShell is only one example of a scripting technology that may be used for carrying out the resolving and verifying portions of a troubleshooting process, and that other scripting technologies and other styles of computer-executable instructions may be used.

FIG. 8B shows a continuation of the troubleshooting manifest of FIG. 8A that includes a description of various display elements that may be used in a user interface related to a troubleshooting package. These “interactions” may offer the ability to receive user input for use during a troubleshooting process. For example, a first “Single Response Interaction”—a type of user interface element that may be supported by the framework, and included in a user interface when described by the troubleshooting package—is described in lines 3-27 of FIG. 8B, which enables a user to select, from options, a type of audio equipment with which the user is having problems: “speakers/headphones/headset earphone” or “microphone/headset microphone” are the two choices given that may be included in the user interface rendered by the troubleshooting framework. Each of these choices includes display information, again referenced in a particular DLL file as in examples shown in FIG. 8A. Each choice also references an icon to be shown with the choice in the user interface, such as a picture that may be shown to aid the user in selecting what equipment is having problems.

Returning again to FIG. 7, a troubleshooting package 700 may also include other components. For example, a troubleshooting package may include troubleshooting facilities 710. Troubleshooting facilities 710 may include any suitable facilities for carrying out troubleshooting processes, including descriptions of tasks to be carried out by a troubleshooting framework and/or scripts to be executed by a troubleshooting framework. Troubleshooting facilities 710 may include diagnosis facilities 712, resolution facilities 714, and/or verification facilities 716 to carry out each of a diagnosis portion, a resolution portion, and a verification portion of a troubleshooting process. In the example of FIGS. 8A and 8B, each of the PS1 files used as troubleshooters, resolvers, and verifiers may be included in the package as troubleshooting facilities 710.

A troubleshooting package 700 may also include information to be used in confirming the authenticity and security of the package and to ensure that it has not been tampered with. This information may include a security catalog 718. The security catalog 718 may be a listing of other components of the troubleshooting package 700 that may be useful in confirming whether an item that is included in the package 700 is a legitimate component of the package 700. Security catalog 718 may also be used to detect an illegitimate component added by, for example, an attacker, by recognizing when a component of the troubleshooting package 700 is not included in the security catalog 718. The security catalog 718 may also include any suitable information for confirming the authenticity of each component, such as a correct hash value (e.g., result of an MD5 hash of a component) for each component of the troubleshooting package 700 and, in some implementations, the troubleshooting package 700 itself. Security catalog 718 may also include a digital signature 720 for the package 700, that may indicate a party that confirmed the authenticity of the package 700 and an identifier for the package 700 that may be used to confirm, with the party, the authenticity of the package 700 in any suitable authentication process.

In addition to components that relate directly to the functionality of a troubleshooting process, a troubleshooting package 700 may, in some implementations, also include resources 722 that may enable the functionality of the package 700. For example, resources 722 may include image display elements 724 and textual display elements 726 to be included in user interfaces rendered according to instructions of the troubleshooting package 700. Resources 722 may also include libraries 728, such as DLLs, that include information (e.g., data and/or instructions) on which other components of the troubleshooting package 700 depend. For example, the libraries 728 may include information such as text to be displayed in a user interface, as described above in connection with FIGS. 8A and 8B. As another example, the libraries 728 may include functionality that may be used by troubleshooting facilities 710, such as functions that the facilities 710 may direct a troubleshooting framework to execute. Any suitable information may be included in resources 722.

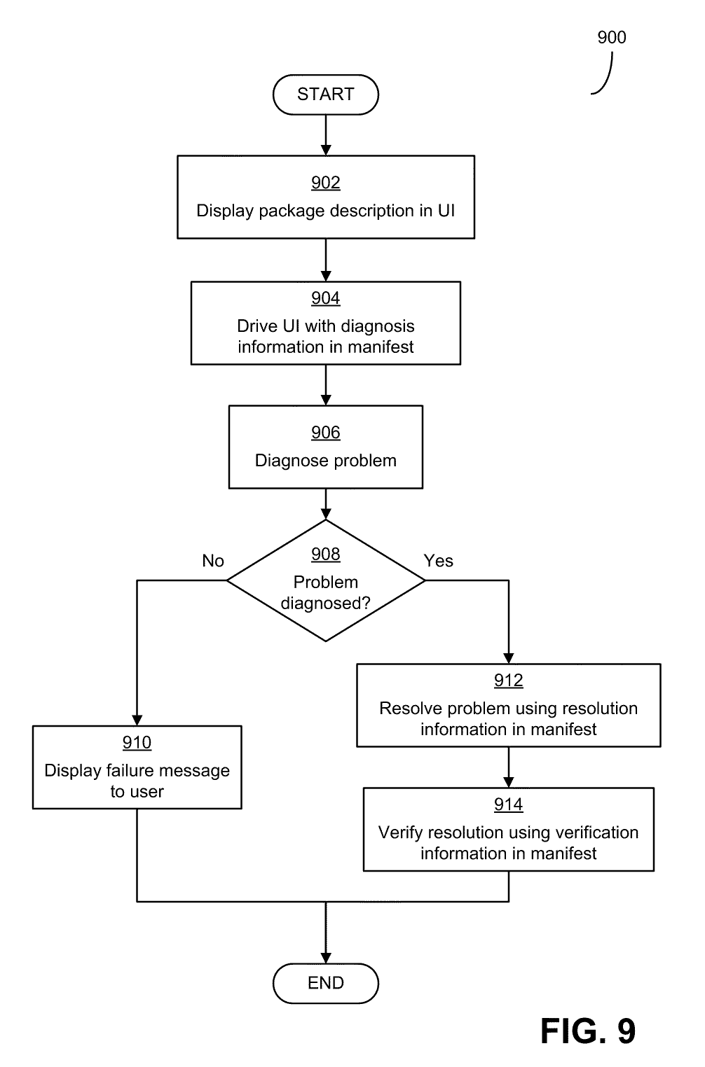

A troubleshooting package like the one shown in FIG. 7 may be used in any suitable manner to provide direction to a troubleshooting framework to carry out a troubleshooting process. FIG. 9 shows one example of a process that may be followed by a troubleshooting package to provide direction to a troubleshooting framework. It should be appreciated, however, that the process shown in FIG. 9 is merely illustrative of the ways in which a package may provide direction to a troubleshooting framework, and that other ways are possible.

The process 900 of FIG. 9 begins in block 902, in which the package provides direction to the troubleshooting framework to render a user interface including a description of the package. The description of the package may be, in whole or in part, a problem statement of the troubleshooting package that describes one or more problems that the package is designed/intended to solve. Displaying the description in block 902 may be done in any suitable manner, including by providing text and/or images to a troubleshooting framework that is adapted to review the troubleshooting package containing the text and/or images, and to present the text and/or images in a user interface according to the description of the text and/or images.

In block 904, as part of a diagnosis portion of a troubleshooting process, the troubleshooting framework may render a user interface using diagnosis information from the troubleshooting package. The diagnosis information may include information about a status of a troubleshooting process (e.g., a status of an automatic process, such as shown in FIG. 5B), and/or information that requests information from a user (e.g., prompts for input, as shown in FIG. 4C).

In block 906, the troubleshooting framework may diagnose the problem based on a description of diagnosis tasks provided by the troubleshooting portion and based on information collected from users and/or information automatically detected and/or retrieved by the troubleshooting package. Diagnosing the problem may be done in any suitable manner, such as by determining (e.g., by executing functions and/or scripts) whether one or more conditions is met by a computing device or components of a computing device, and matching those one or more conditions to root causes of a problem. For example, as discussed above in connection with FIG. 8A, if the user is experiencing a problem with an audio system of a computing device (e.g., not producing sound), a root cause of the problem may be that an audio service is not enabled for the computing device. Diagnosing the problem in block 906, then, may include determining conditions related with each root cause of the problem, checking whether the conditions are met (e.g., whether the audio service is disabled) and, if so, diagnosing the problem as being caused by one of the root causes. The troubleshooting package may provide direction to the troubleshooting framework to carry out the diagnosis of block 906 by providing a set of root causes and conditions to be examined, and/or by providing computer-executable instructions, such as a script, to be executed by the framework.

In block 910, it is determined whether the problem was diagnosed in block 906. If not—in other words, if none of the root causes of the problem were identified as present, based on the conditions of the root cause—then in block 910 the troubleshooting package may provide direction to the troubleshooting interface to render a user interface displaying a failure message to a user, indicating that the troubleshooting package was not able to resolve the problem, and the troubleshooting process 900 ends.

If, however, it is determined in block 908 that the problem was diagnosed—in other words, that one of the root causes did exist—then process 900 proceeds to resolve the problem in block 912. The troubleshooting package may provide direction to the troubleshooting framework to resolve the problem using resolution information referenced in the manifest, which may include a reference to one or more scripts to be executed by the framework or any other suitable information. Once the problem has been resolved in block 912 according to the resolution information, then in block 914 the troubleshooting package provides direction to the troubleshooting framework to verify the resolution using verification information in the manifest. Again, the verification information may be any suitable information, including a script to be executed by the troubleshooting framework and/or a description of a task to be completed that may be interpreted by the troubleshooting framework.

Once the resolution has been verified in block 914, then the troubleshooting process 900 ends.

Techniques operating according to the principles described herein may be implemented in any suitable manner. Included in the discussion above are a series of flow charts showing the steps and acts of various processes that enable a common troubleshooting framework that may operate as directed by troubleshooting packages to carry out troubleshooting processes. The processing and decision blocks of the flow charts above represent steps and acts that may be included in algorithms that carry out these various processes. Algorithms derived from these processes may be implemented as software integrated with and directing the operation of one or more multi-purpose processors, may be implemented as functionally-equivalent circuits such as an Application-Specific Integrated Circuit (ASIC), or may be implemented in any other suitable manner. It should be appreciated that the flow charts included herein do not depict the syntax or operation of any particular circuit, or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and acts described in each flow chart is merely illustrative of the algorithms that may be implemented and can be varied in implementations and embodiments of the principles described herein without departing from the invention.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or in series, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. These functional facilities may, in alternative embodiments, be adapted to interact with other, unrelated functional facilities and/or processes, to implement a software program application. In other implementations, the functional facilities may be adapted to interact with other functional facilities in such a way as form an operating system, including the Windows operating system, available from the Microsoft Corporation of Redmond, Wash. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that the invention is not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

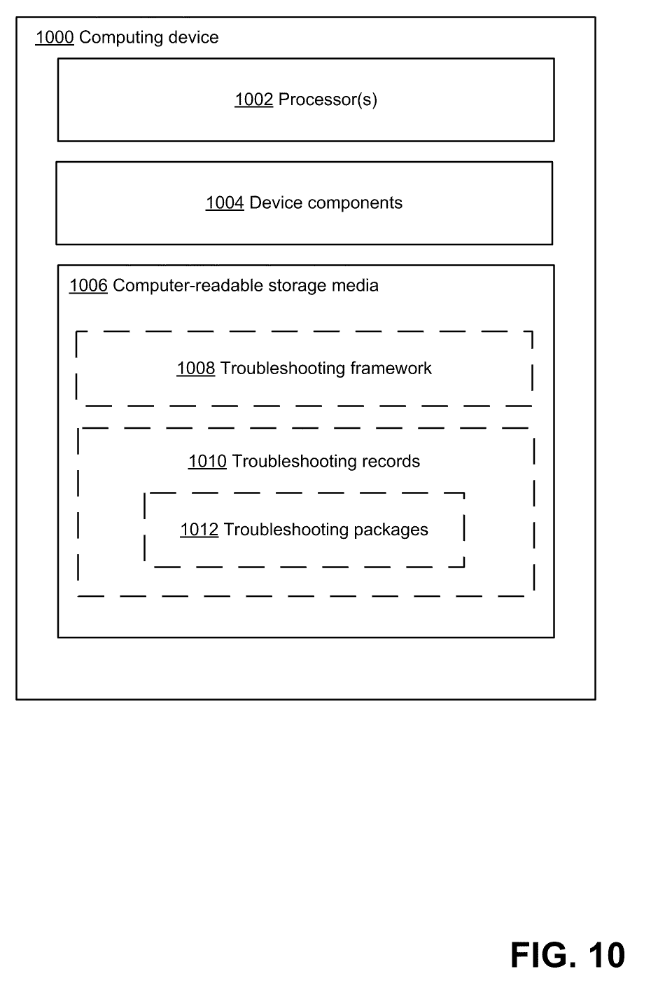

Computer-executable instructions implementing the techniques described herein (when implemented as one or more functional facilities or in any other manner) may, in some embodiments, be encoded on one or more computer-readable storage media to provide functionality to the storage media. These media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable storage medium may be implemented as computer-readable storage media 1006 of FIG. 10 described below (i.e., as a portion of a computing device 1000) or as a stand-alone, separate storage medium. It should be appreciated that, as used herein, a “computer-readable media,” including “computer-readable storage media,” refers to tangible storage media having at least one physical property that may be altered in some way during a process of recording data thereon. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIGS. 1A and 1B. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 10 illustrates one exemplary implementation of a computing device in the form of a computing device 1000 that may be used in a system implementing the techniques described herein, although others are possible. It should be appreciated that FIG. 10 is intended neither to be a depiction of necessary components for a computing device to operate in accordance with the principles described herein, nor a comprehensive depiction.

Computing device 1000 may comprise at least one processor 1002, a network adapter 1004, and computer-readable storage media 1006. Computing device 1000 may be, for example, a desktop or laptop personal computer, a personal digital assistant (PDA), a smart mobile phone, a server, a wireless access point or other networking element, or any other suitable computing device that may carry out a troubleshooting process. Device components 1004 may be any suitable hardware and/or software that may be used in a computing device, such as input/output components of a computing device. Computer-readable storage media 1006 may be adapted to store data to be processed and/or instructions to be executed by processor 1002. Processor 1002 enables processing of data and execution of instructions. The data and instructions may be stored on the computer-readable storage media 1006 and may, for example, enable communication between components of the computing device 1000.

The data and instructions stored on computer-readable storage media 1006 may comprise computer-executable instructions implementing techniques which operate according to the principles described herein. In the example of FIG. 10, computer-readable storage media 1006 stores computer-executable instructions implementing various facilities and storing various information as described above. Computer-readable storage media 1006 may store a troubleshooting framework 1008, including components for carrying out troubleshooting processes as directed by troubleshooting packages. The computer-readable storage media 1006 may also include troubleshooting records 1010 that store any suitable information relating to a troubleshooting framework 1008, including one or more troubleshooting packages 1012.

While not illustrated in FIG. 10, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the invention have been described where the techniques are implemented in circuitry and/or computer-executable instructions. It should be appreciated that the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method of operating a computing device, on which is implemented a troubleshooting framework, to troubleshoot a problem being experienced by the computing device, the method comprising:
(A) identifying a troubleshooting package to be executed, the troubleshooting package comprising a problem statement being related to the problem and an identification of one or more causes of the problem; and
(B) controlling a troubleshooting framework based on contents of the troubleshooting package, the troubleshooting framework rendering a user interface populated according to the contents of the troubleshooting package.

2. The method of claim 1, wherein the act (B) of controlling the troubleshooting framework comprises:
(B1) executing at least one set of computer-executable instructions contained within the troubleshooting package.

3. The method of claim 2, wherein the at least one set of computer-executable instructions is at least one computer programming script.

4. The method of claim 2, wherein the at least one set of computer-executable instructions is a set of computer-executable instructions that performs one of diagnosing, resolving, or verifying solution of a root cause of the one or more root causes of the problem.

5. The method of claim 1, wherein the act (B) of controlling the troubleshooting framework comprises:
(B1) generating a user interface element based on a description of a desired user interface element, the description being contained in the troubleshooting package; and
(B2) displaying the user interface element to the user.

6. The method of claim 1, wherein the act (B) of controlling the troubleshooting framework comprises:
(B1) interpreting a description of a desired diagnostic task, the description being contained in the troubleshooting package; and
(B2) performing at least one diagnostic function based on the interpreting of act (B1).

7. The method of claim 6, wherein the description comprises at least one value indicating a property of the troubleshooting package, and interpreting in act (B1) comprises selecting the at least one diagnostic function based on the at least one value.

8. The method of claim 7, wherein the at least one value is a true or false value indicating whether the troubleshooting package should be executed with administrator privileges, and interpreting in act (B1) comprises prompting a user for login information for administrator access when the true or false value is true.

9. At least one computer-readable storage medium encoded with computer-executable instructions that, when executed by a computer, cause the computer to carry out a method of operating a computing device, on which is implemented a troubleshooting framework, to troubleshoot a problem being experienced by the computing device, the method comprising:
(A) presenting to a user a listing of at least one potential troubleshooting package useful in troubleshooting the problem, each troubleshooting package comprising a problem statement being related to the problem, an identification of one or more root causes of the problem, and at least one set of computer-executable instructions that performs one of diagnosing, resolving, or verifying solution of a cause of the one or more root causes of the problem;
(B) controlling a troubleshooting framework based on contents of a selected troubleshooting package, the troubleshooting framework rendering a user interface populated according to the contents of the selected troubleshooting package; and
(C) upon completion of processing associated with the selected troubleshooting package, reporting to a repository of troubleshooting information whether the troubleshooting package was successful in solving the problem.

10. The at least one computer-readable storage medium of claim 9, wherein at least some of the potential troubleshooting packages included in the listing of the at least one potential troubleshooting package presented in the act (A) are troubleshooting packages available for download to the computing device over a network.

11. The at least one computer-readable storage medium of claim 10, wherein the network is the Internet.

12. The at least one computer-readable storage medium of claim 10, wherein the method further comprises:
(D) retrieving the selected troubleshooting package over the network, and storing it on the computing device.

13. The at least one computer-readable storage medium of claim 10, wherein the act (B) of controlling the troubleshooting framework comprises:
(B1) generating a user interface element based on a description of a user interface element, the description being contained in the troubleshooting package; and
(B2) displaying the user interface element to the user.

14. The at least one computer-readable storage medium of claim 10, wherein the act (B) of controlling the troubleshooting framework comprises:
(B1) interpreting a description of a desired diagnostic task, the description being contained in the troubleshooting package; and
(B2) performing at least one diagnostic function based on the interpreting of act (B1).

15. The at least one computer-readable storage medium of claim 10, wherein the act (C) of reporting comprises:
(C1) transmitting an indication of whether the troubleshooting package was successful in solving the problem to a remote repository of troubleshooting information, the remote repository being associated with at least one distributor of troubleshooting packages.

16. An apparatus, on which is implemented a troubleshooting framework, to troubleshoot a problem being experienced by a user of the computing device, the apparatus comprising:
at least one processor adapted to perform a troubleshooting process for the troubleshooting framework by:
reviewing contents of a troubleshooting package, the troubleshooting package comprising a description of at least one task to be carried out as part of the troubleshooting process;
interpreting the contents to identify at least one function to be performed to carry out the at least one task; and
performing the at least one function.

17. The apparatus of claim 16, wherein performing the at least one function comprises generating one or more display elements according to the description of the troubleshooting package, and rendering a user interface including the one or more display elements.

18. The apparatus of claim 16, wherein the description comprises at least one value indicating a property of the troubleshooting package, and interpreting comprises selecting the at least one diagnostic function based on the at least one value.

19. The apparatus of claim 18, wherein the at least one value is a true or false value indicating whether the troubleshooting package should be executed with administrator privileges, and performing the at least one function comprises prompting a user for login information for administrator access when the true or false value is true.

20. The apparatus of claim 16, wherein the description comprises at least one set of computer-executable instructions that performs one of diagnosing, resolving, or verifying solution of a root cause of the problem, and wherein performing the at least one function comprises executing the at least one set of computer-executable instructions.
